(19) United States
(12) Patent Application Publication
(10) Pub. No.: US 2017/0146867 A1
(43) Pub. Date: May 25, 2017

(54) CAPACITIVE TOUCH SCREEN AND PREPARATION METHOD THEREOF AND TOUCH DISPLAY PANEL

(71) Applicants: BOE TECHNOLOGY GROUP CO., Beijing (CN); HEFEI BOE OPTOELECTRONICS TECHNOLOGY CO., LTD., Hefei, Anhui (CN)

(72) Inventor: Sheng WANG, Beijing (CN)

(21) Appl. No.: 15/100,088

(22) PCT Filed: Aug. 21, 2015
(86) PCT No.: PCT/CN2015/087828

§ 371 Date: May 27, 2016

(30) Foreign Application Priority Data
Apr. 17, 2015 (CN) 201510185776.X

(51) Int. Cl. G02F 1/1343; G06F 3/041; G02F 1/1333; G06F 3/044

(52) U.S. Cl. CPC G02F 1/134309; G06F 3/044; G06F 3/0412; G06F 3/0416; G02F 1/13338; G02F 1/13439

(57) ABSTRACT

A capacitive touch screen and a preparation method thereof and a touch display panel are provided. The capacitive touch screen includes a substrate, a plurality of touch electrodes provided on the substrate, and a plurality of signal lines corresponding to the plurality of touch electrodes. The substrate includes a touch region for touching and a signal line connection region for external connection of the signal lines, the plurality of touch electrodes are provided in the touch region, and the plurality of signal lines are routed from the touch region to the signal line connection region. The plurality of touch electrodes and portions of the plurality of signal lines in the touch region are covered with a photoresist, and portions of the plurality of signal lines in the signal line connection region are not covered with the photoresist. It is not easy to scratch the plurality of touch electrodes and the portions of the plurality of signal lines outside the signal line connection region in follow-up processes, so that a product yield is improved.

### TECHNICAL FIELD

Embodiments of the present disclosure relate to a capacitive touch screen and a preparation method thereof and a touch display panel.

### BACKGROUND

With rapid development of tablet smart phones and tablet computers, a touch screen technology has developed rapidly. The touch screen is mainly divided into a resistive type, a capacitive type and an infrared optical type and so on. The touch screen of resistive type is to determine a touch position by pressing to cause change of resistances between two layers of electrodes or electrical connection of the two layers of electrodes; the touch screen of capacitive type is to determine the touch position for example by a capacitance change caused by a human touch; and the touch screen of infrared optical type is to determine the touch position by blocking infrared light to be received for example with fingers. The capacitive touch screen is sensitive, so that the capacitive touch screen is widely used in mobile products.

The capacitive touch screens on the market mainly include: a Glass+Film +Film (GFF) touch screen, a One Glass Solution (OGS) touch screen, an On-Cell touch screen and an In-Cell touch screen. The GFF touch screen is to provided a conductive structure (such as, a ITO layer) on a plastic film (such as, a polyethylene terephthalate (PET) film) by etching or printing and to provide a protective glass as an outer layer; the OGS for example is to bond a glass substrate having a touch function on a surface of a liquid crystal panel; the On-Cell touch screen for example is to fabricate an electrode for implementing the touch function on a surface of a color filter substrate, i.e., the electrode for implementing the touch function is located above the liquid crystal cell; and the In-Cell touch screen is to fabricate the electrode for implementing the touch function in the liquid crystal cell (Cell). Considering factors such as lightness, thinness and cost, the On-Cell touch screen and the In-Cell touch screen arc future development directions. A fabrication process of the On-Cell touch screen is relatively simple, but easy to cause problems such as scratches on the electrode. A fabrication process of the In-Cell touch screen is relatively complex, and touch signals may easily disturb deflections of liquid crystals.

### SUMMARY

According to embodiments of the disclosure, a capacitive touch screen is provided. The capacitive touch screen comprises: a substrate, a plurality of touch electrodes provided on the substrate, and a plurality of signal lines corresponding to the plurality of touch electrodes. The substrate includes a touch region for touching and a signal line connection region for external connection of the signal lines, the plurality of touch electrodes are provided in the touch region, and the plurality of signal lines are routed from the touch region to the signal line connection region, and the plurality of touch electrodes and portions of the plurality of signal lines in the touch region are covered with a photoresist, and portions of the plurality of signal lines in the signal line connection region are not covered with the photoresist.

For example, the touch electrodes comprise a touch driving electrode and/or a touch sensing electrode.

For example, the touch electrodes and the signal lines are provided in a same layer.

For example, the touch electrodes are made of a transparent conductive material.

For example, the substrate further includes a signal line expansion region, the plurality of signal lines enter the touch region after expanded in the signal line expansion region, and portions of the signal lines in the signal line expansion region are covered with the photoresist.

According to embodiments of the disclosure, a preparation method of a capacitive touch screen is provided. The method comprises: forming a plurality of touch electrodes and a plurality of signal lines corresponding to the plurality of touch electrodes on a substrate by a photolithographic process, wherein, the substrate includes a touch region for touching and a signal line connection region for external connection of the signal lines, the plurality of touch electrodes are provided in the touch region, and the plurality of signal lines are routed from the touch region to the signal line connection region; reserving a photoresist used in the photolithographic process on the plurality of touch electrodes and portions of the plurality of signal lines in the touch region without reserving photoresist on portions of the plurality of signal lines in the signal line connection region.

For example, the photolithographic process uses a multi-tone mask.

For example, the multi-tone mask is a half-tone mask or a gray-tone mask.

For example, the photolithographic process using the multi-tone mask includes: forming a transparent conductive film on the substrate; forming a photoresist film on the transparent conductive film; exposing, developing the photoresist film to form a photoresist pattern, wherein, a thickness of a portion of the photoresist pattern in the signal line connection region is less than a thickness of a portion of the photoresist pattern in the touch region; etching the transparent conductive film by using the photoresist pattern as a mask, to form the touch electrodes and the signal lines; asking the photoresist pattern, to remove the portion of the photoresist pattern in the signal line connection region but reserve the portion of the photoresist pattern having a reduced thickness in the touch region.

For example, in the case that the photoresist film is formed of a positive photoresist, a region to be etched corresponds to a completely-transmissive region of the multi-tone mask, a region for forming the portions of the signal lines in the signal line connection region corresponds to a semi-transmissive region of the multi-tone mask, and a region for forming the touch electrodes and the portions of the signal lines in the touch region corresponds to a light-tight region of the multi-tone mask.

For example, the substrate further includes a signal line expansion region, the plurality of signal lines enter the touch region after expanded in the signal line expansion region, and the photoresist is also reserved on portions of the signal lines in the signal line expansion region.

For example, the transparent conductive film is made of a transparent conductive material.

For example, the substrate is an opposed substrate in a liquid crystal display panel.

According to embodiments of the disclosure, a touch display panel is provided. The touch display panel comprises a display panel and a touch structure located on the display panel. The touch structure includes a plurality of touch electrodes, and a plurality of signal lines corresponding to the plurality of touch electrodes; the display panel includes a touch region for touching and a signal line connection region for external connection of the signal lines, the plurality of touch electrodes are provided in the touch region, and the plurality of signal lines are routed from the touch region to the signal line connection region; and the plurality of touch electrodes and portions the plurality of signal lines in the touch region are covered with a photoresist, and portions of the plurality of signal lines in the signal line connection region are not covered with the photoresist.

For example, the display panel further includes a signal line expansion region, the plurality of signal lines enter the touch region after expanded in the signal line expansion region, and portions of the signal lines in the signal line expansion region are covered with the photoresist.

For example, the touch electrodes and the signal lines are provided in a same layer.

For example, the touch electrodes are made of a transparent conductive material.

For example, the display panel is a liquid crystal panel, and includes an array substrate, an opposed substrate, and liquid crystal sealed between the array substrate and the opposed substrate by a sealant.

For example, the touch structure is provided on the opposed substrate.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative of the present disclosure.

FIG. 1a is a schematic view of an OGS touch display panel;

FIG. 1b is a schematic view of an On-Cell capacitive touch display panel;

FIG. 2a is a schematic view of a capacitive touch screen in which a touch region, a signal line expansion region and a signal line connection region of a substrate are illustrated;

FIG. 2b is a schematic view of a display region, a touch region corresponding to the display region, a signal line expansion region and a signal line connection region of a display panel in an On-Cell capacitive touch display panel;

FIG. 3a is a schematic view of a capacitive touch screen provided by embodiments of the present disclosure;

FIG. 3b is a schematic view of an OGS touch display panel provided by the embodiments of the present disclosure;

FIG. 3c is a schematic view of an On-Cell capacitive touch display panel provided by the embodiments of the present disclosure;

FIG. 3d is a schematic view of an On-Cell capacitive touch display panel provided by the embodiments of the present disclosure;

FIG. 3e is a schematic view of a GFF touch display panel provided by the embodiments of the present disclosure;

FIG. 4a is a schematic view of forming a transparent conductive film and a photoresist film on a substrate in a preparation method of a capacitive touch screen provided by the embodiments of the present disclosure;

FIG. 4b is a schematic view of exposing and developing the photoresist film to form a photoresist pattern in the preparation method of the capacitive touch screen provided by the embodiments of the present disclosure;

FIG. 4c is a schematic view of etching by using the photoresist pattern as a mask in the preparation method of the capacitive touch screen provided by the embodiments of the present disclosure; and

FIG. 4d is a schematic view of ashing the photoresist pattern in the preparation method of the capacitive touch screen provided by the embodiments of the present disclosure.

### DETAILED DESCRIPTION

In order to make objects, technical details and advantages of the embodiments of the present disclosure apparent, the technical solutions of the embodiment will be described in a clearly and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s), without any inventive work, which should be within the scope of the present disclosure.

In the embodiments of the present disclosure, a photolithographic process is one of the patterning processes. The photolithographic process refers to a process of forming a pattern by forming a film, exposing, developing, etching, ashing and so on with using a photoresist, a mask, an exposing machine, an etching machine and the like.

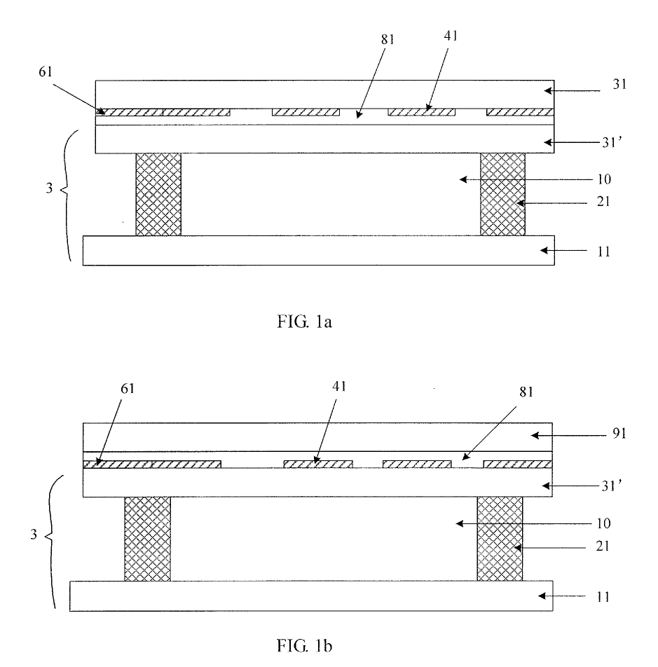

FIG. 1a is a schematic view of an OGS capacitive touch display panel. A plurality of touch electrodes 41 and a plurality of signal lines 61 corresponding to the touch electrodes are provided on a substrate 31 of the OGS touch display panel, a optically clear adhesive layer 81 is provided on the touch electrodes 41 and the signal lines 61, and the substrate 31, the plurality of touch electrodes 41 and the plurality of signal lines 61 provided on the substrate 31 are bonded with a display panel 3 via the optically clear adhesive layer 81. The display panel 3 for example is a liquid crystal panel, and includes an array substrate 11, an opposed substrate 31′, and liquid crystals 10 sealed between the array substrate 11 and the opposed substrate 31′ by a sealant 21. The opposed substrate and the array substrate are provided opposite to each other, and the opposed substrate and the array substrate are upper and lower substrates of the display panel, respectively; generally, a display structure such as a film transistor array is formed on the array substrate, and a color resin is formed on the opposed substrate. For example, the opposed substrate is a color filter substrate. That is, the substrate 31, the plurality of touch electrodes 41 and the plurality of signal lines 61 provided on the substrate 31 are bonded with the opposed substrate 31′ of the display panel 3 via the optically clear adhesive layer 81. At this moment, the substrate 31 may be a glass substrate.

FIG. 1b is a schematic view of an On-Cell capacitive touch display panel. The On-Cell capacitive touch display panel includes a display panel 3 and a touch structure provided on the display panel 3; the display panel 3 is for example a liquid crystal panel and includes an array substrate 11, an opposed substrate 31′, and liquid crystals 10 sealed between the array substrate 11 and the opposed substrate 31′ by a sealant 21, and meanwhile the opposed substrate 31′ serves as a substrate of the touch screen; the touch structure includes a plurality of touch electrodes 41 and a plurality of signal lines 61 corresponding to the plurality of touch electrodes provided on the opposed substrate 31′; a optically clear adhesive layer 81 and a cover plate 91 are sequentially provided on the plurality of touch electrodes 41 and the plurality of signal lines 61; and the substrate 31′, the plurality of touch electrodes 41 and the plurality of signal lines 61 provided on the substrate 31′ are bonded with the cover plate 91 via the optically clear adhesive layer 81.

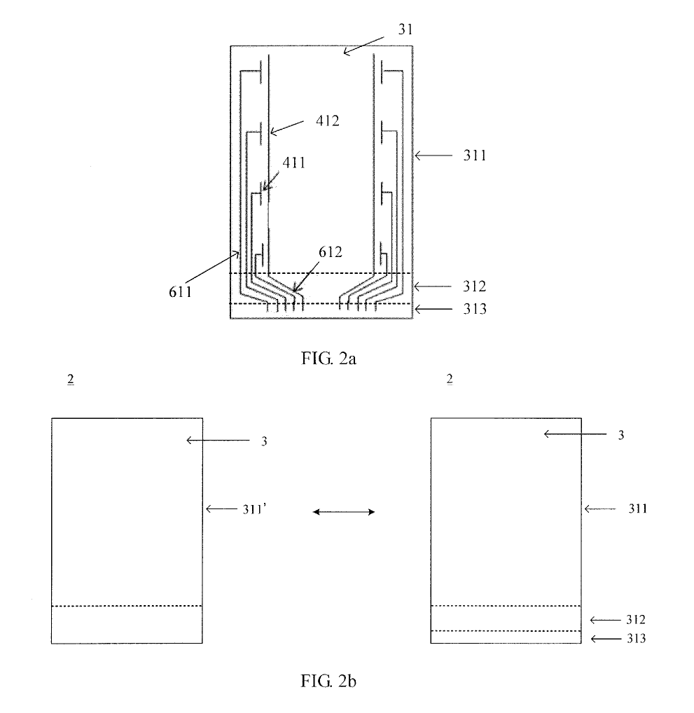

As shown in FIG. 2a, in the above-described capacitive touch screen, the substrate 31 or 31′ includes a touch region 311 for touching and a signal line connection region 313 for external connection of the signal lines, the plurality of touch electrodes 41 are provided in the touch region 311, and the plurality of signal lines 61 are routed from the touch region 311 to the signal line connection region 313. The substrate 31 or 31′ further includes a signal line expansion region 312, and the plurality of signal lines 61 enter into the touch region 311 after expanded in the signal line expansion region 312.

As shown in FIG. 2b, in the On-Cell capacitive touch display panel, the display panel 3 includes a display region 311′ for displaying, for example, the touch region 311 for touching corresponds to the display region 311′ for displaying in position; and the display panel 3 further includes the signal line connection region 313 for external connection of the signal lines, the plurality of touch electrodes 41 are provided in the touch region 311, and the plurality of signal lines 61 are routed from the touch region 311 to the signal line connection region 313. The display panel 3 for example further includes the signal line expansion region 312, and the plurality of signal lines 61 enter into the touch region 311 after expanded in the signal line expansion region 312.

The touch electrodes 41 for example include a touch driving electrode Tx and a touch sensing electrode Rx; and the touch driving electrode Tx and the touch sensing electrode Rx for example are formed in a same layer, for example, the touch driving electrode Tx and the touch sensing electrode Rx are formed by a transparent conductive film of a same layer of. In the OGS touch display panel of FIG. 1a and the On-Cell capacitive touch display panel of FIG. 1b, the touch electrodes 41 and the signal lines 61 corresponding to the touch electrodes 41 are shown in FIG. 2a. The touch electrodes 41 include the touch driving electrode 411 and the touch sensing electrode 412; the touch signal lines 61 include a touch driving signal line 611 corresponding to the touch driving electrode 411 and a touch sensing signal line 612 corresponding to the touch sensing electrode 412.

For example, a structure in which a side of the touch sensing electrode 412 is provided with four touch driving electrodes 411 is employed; or a structure in which four touch driving electrodes 411 are provided on both sides of the touch sensing electrode 412 is employed, so that the touch sensing electrode 412 corresponds to eight touch driving electrodes 411. For example, the above structures may serve as a basic touch unit and be repeatedly provided in the touch region in an array manner. The structure of the touch electrode 41 is not specifically limited here. For example, the touch driving electrode 411 and the touch sensing electrode 412 may be exchanged with each other, and accordingly, the touch driving signal line 611 and the touch sensing signal line 612 may be exchanged with each other. For example, in the case that a capacitance between the touch driving electrode Tx and the touch sensing electrode Rx is changed due to a touching of a finger, the touch position is determined by detecting a signal output caused by coupling a touch driving signal on the touch sensing electrode Rx. In this way, the touching operation is implemented.

In the preparation processes of the OGS touch display panel and the On-Cell capacitive touch display panel, after forming the touch electrodes 41 and the signal lines 61, it is necessary to bond a touch flexible print circuit (FPC) board on the signal line connection region 313. However, in the case that the touch FPC is bonded, the touch electrodes 41 are very easily scratched, which reduces a product yield.

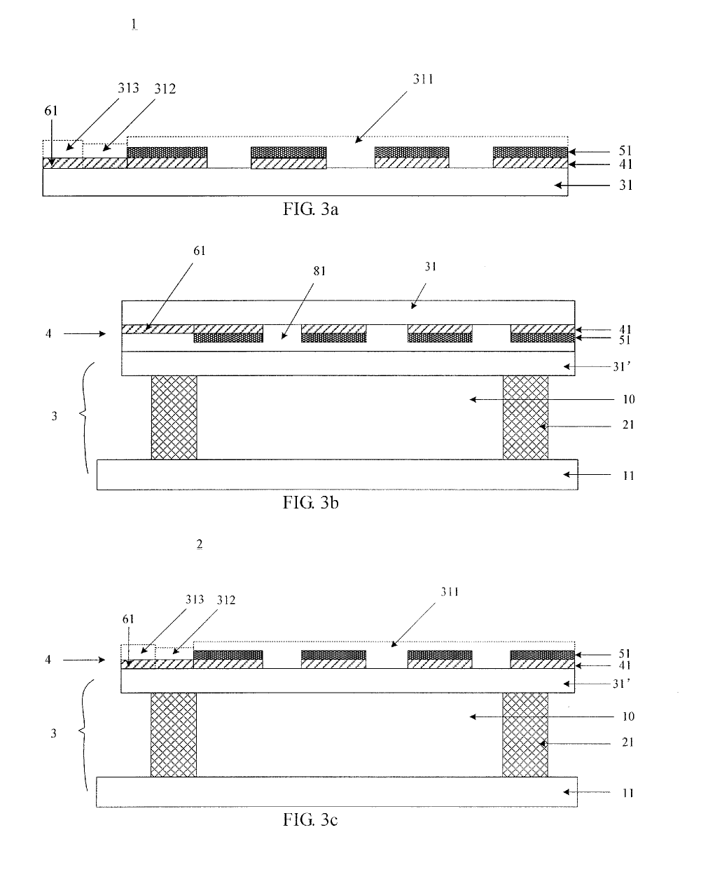

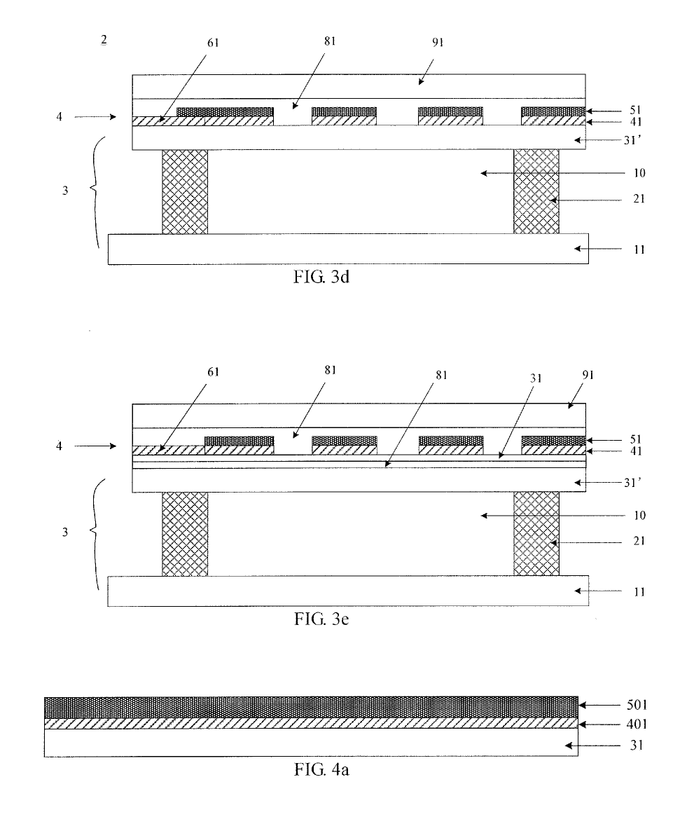

Embodiments of the present disclosure provide a capacitive touch screen 1, as shown in FIG. 3a, the capacitive touch screen 1 comprises: a substrate 31, a plurality of touch electrodes 41 provided on the substrate 31, and a plurality of signal lines 61 corresponding to the plurality of touch electrodes 41; the substrate 31 includes a touch region 311 for touching and a signal line connection region 313 for external connection of the signal lines; the plurality of touch electrodes 41 are provided in the touch region 311, the plurality of signal lines 61 are routed from the touch region 311 to the signal line connection region 313, the plurality of touch electrodes 41 and portions of the plurality of signal lines 61 in the touch region 311 are covered with a photoresist 51, and portions of the plurality of signal lines 61 in the signal line connection region 313 are not covered with the photoresist. Since the plurality of touch electrodes 41 and portions of the plurality of signal lines 61 in the touch region 311 are covered with the photoresist 51, the photoresist 51 protects the electrodes or signal lines therebelow in follow-up processes such as a bonding process. For example, it is referred to FIG. 2a for the touch region 311 and the signal line connection region 313.

For example, in the capacitive touch screen provided by the embodiments of the present disclosure, the touch electrodes 41 comprises a touch driving electrode 411 and/or a touch sensing electrode 412, and accordingly, the touch signal lines 61 comprises a touch driving signal line 611 and/or a touch sensing signal line 612. The touch electrodes 411, 412 and the signal lines 611, 612 are shown in FIG. 2a as an example. The touch electrodes 41 are provided in the touch region.

For example, in the capacitive touch screen provided by the embodiments of the present disclosure, the touch electrodes 41 and the signal lines 61 are provided in a same layer and formed by a transparent conductive film of a same layer, thus the touch electrodes 41 and the signal lines 61 are made of a same material.

For example, in the capacitive touch screen provided by the embodiments of the present disclosure, the touch electrodes 41 are made of a transparent conductive material, such as indium tin oxide (ITO), indium zinc oxide (IZO) and so on.

For example, in an OGS touch screen provided by the embodiments of the present disclosure, an optically clear adhesive (OCA) layer 81 is provided, for example, the formed OGS touch display panel is shown in FIG. 3b. The substrate 31, the plurality of touch electrodes 41 and the plurality of signal lines 61 provided on the substrate 31 and the photoresist covering the plurality of touch electrodes 41 and the plurality of signal lines 61 are bonded with an opposed substrate 31′ of a display panel via the optically clear adhesive layer 81. The display panel 3 for example is a liquid crystal panel, and includes an array substrate 11, an opposed substrate 31′ and liquid crystals 10 scaled between the array substrate 11 and the opposed substrate 31′ by a sealant 21. The opposed substrate and the array substrate are provided opposite to each other, and the opposed substrate and the array substrate are upper and lower substrates of the display panel, respectively. For example, a display structure such as an array of thin film transistors is formed on the array substrate, and a color resin is formed on the opposed substrate. For example, the opposed substrate is a color filter substrate. That is, the substrate 31, the plurality of touch electrodes 41 and the plurality of signal lines 61 provided on the substrate 31 are bonded with the display panel 3 via the optically clear adhesive layer 81.

For example, the substrate 31 further includes a signal line expansion region 312, and the plurality of signal lines 61 enter the touch region 311 after expanded in the signal line expansion region 312. For example, portions of the signal lines 61 in the signal line expansion region 312 are covered with the photoresist. For example, FIG. 2a is referred to for the signal line expansion region 312.

The embodiments of the present disclosure further provide an On-Cell capacitive touch display panel, as shown in FIG. 3c, comprising a display panel 3 and a touch structure 4 provided on the display panel 3; the touch structure 4 includes the plurality of touch electrodes 41, and the plurality of signal lines 61 corresponding to the plurality of touch electrodes 41; the display panel includes a display region for displaying (not shown, referring to the display region 311′ in FIG. 2b), the touch region 311 for touching and corresponding to the display region for displaying; the display panel further includes the signal line connection region 313 for external connection of the signal lines; the plurality of touch electrodes 41 are provided in the touch region 311, and the plurality of signal lines 61 are routed from the touch region 311 to the signal line connection region 313; the plurality of touch electrodes 41 and portions of the plurality of signal lines 61 in the touch region 311 are covered with the photoresist 51, and portions of the plurality of signal lines 61 in the signal line connection region 313 are not covered with the photoresist. For example, FIG. 2b is referred to for the display region, the touch region and the signal line connection region.

The touch region 311 for touching corresponds to the display region 311′ for displaying, for example, a projection of the display region 311′ on the display panel and a projection of the touch region 311 on the display panel have an overlapping region.

For example, an area of the touch region 311 is equal to that of the display region 311′; of course, the area of the touch region 311 may be greater or less than that of the display region 311′, which is not limited by the embodiments of the present disclosure.

For example, in the capacitive touch screen provided by the embodiments of the present disclosure, the touch electrodes 41 comprises the touch driving electrode 411 and/or the touch sensing electrode 412; and accordingly, the touch signal lines 61 comprises the touch driving signal line 611 and the touch sensing signal line 612. The touch electrodes 411, 412 and the signal lines 611, 612 thereof are shown in FIG. 2a as an example. The touch electrodes 41 are provided in the touch region.

For example, in the On-Cell capacitive touch display panel provided by the embodiments of the present disclosure, the touch electrodes 41 and the signal lines 61 are provided in a same layer and formed by a transparent conductive film of a same layer of, thus the touch electrodes 41 and the signal lines 61 are made of a same material.

For example, in the On-Cell capacitive touch display panel provided by the embodiments of the present disclosure, the display panel 3 is the liquid crystal panel, and includes the array substrate 11, the opposed substrate 31′, and the liquid crystals 10 sealed between the array substrate 11 and the opposed substrate 31′ by the sealant 21. The opposed substrate and the array substrate are provided opposite to each other, and the opposed substrate and the array substrate are upper and lower substrates of the display panel, respectively. For example, the display structure such as the array of thin film transistors is formed on the array substrate, and the color resin is formed on the opposed substrate. The opposed substrate 31′, for example, is the color filter substrate.

For example, the touch structure 4 is provided on the opposed substrate, as shown in FIG. 3c.

For example, in the On-Cell capacitive touch display panel provided by the embodiments of the present disclosure, the touch electrodes are made of the transparent conductive material, such as indium tin oxide (ITO), indium zinc oxide (IZO) and so on.

For example, in the On-Cell capacitive touch display panel provided by the embodiments of the present disclosure, the Optically Clear Adhesive (OCA) layer 81 and a cover plate 91 are further provided, as shown in FIG. 3d. The opposed substrate 31′, the plurality of touch electrodes 41 and the plurality of signal lines 61 provided on the opposed substrate 31′ and the photoresist covering the plurality of touch electrodes 41 and the plurality of signal lines 61 are bonded with the cover plate 91 via the optically clear adhesive layer 81. The cover plate, for example, is made of glass.

For example, the embodiments of the present disclosure provide a touch screen of GFF type, and such capacitive touch screen comprises: the substrate 31, the plurality of touch electrodes 41 provided on the substrate 31, and the plurality of signal lines 61 corresponding to the plurality of touch electrodes 41; the substrate 31 for example is a plastic film, and the substrate 31 includes the touch region 311 for touching and the signal line connection region 313 for external connection of the signal lines; the plurality of touch electrodes 41 are provided in the touch region 311, the plurality of signal lines 61 are routed from the touch region 311 to the signal line connection region 313, the plurality of touch electrodes 41 and portions of the plurality of signal lines 61 in the touch region 311 are covered with the photoresist 51, and portions of the plurality of signal lines 61 in the signal line connection region 313 are not covered with the photoresist. Since the plurality of touch electrodes 41 and the portions of the plurality of signal lines 61 in the touch region 311 are covered with the photoresist 51, the photoresist 51 protects the electrodes and the signal lines therebelow in follow-up processes such as the bonding process. FIG. 2a for example is referred to for the touch region 311 and the signal line connection region 313. The touch screen of GFF type is bonded with the display panel 3 via the optically clear adhesive layer 81. A structure of the display panel 3 may be as described above. The formed touch display panel of GFF type is shown in FIG. 3e.

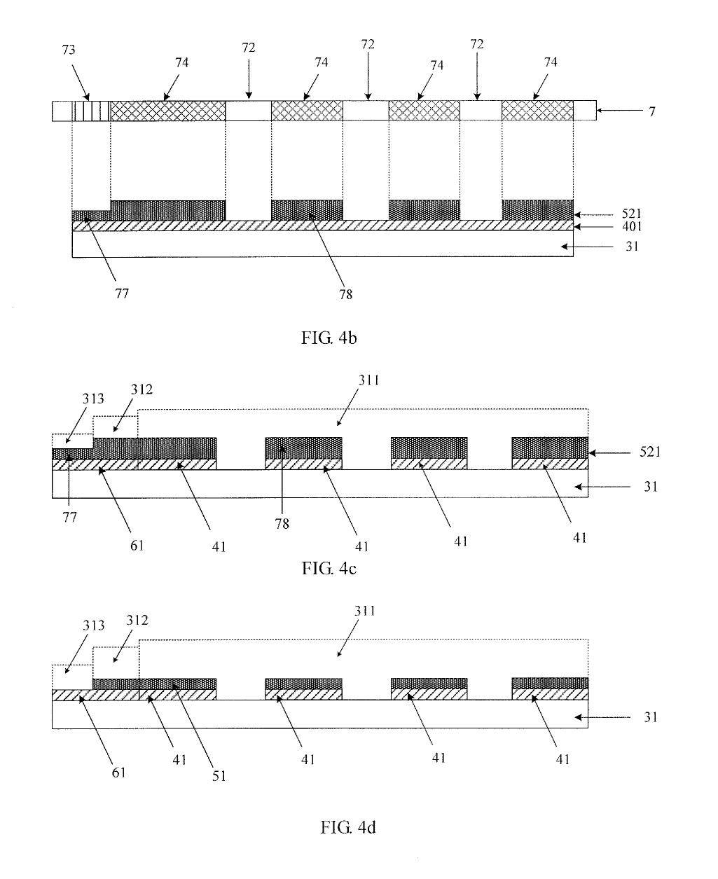

The embodiments of the present disclosure further provide a preparation method of a capacitive touch screen, as shown from FIG. 4a to FIG. 4d.

The preparation method of the capacitive touch screen comprises: forming a plurality of touch electrodes 41 and a plurality of signal lines 61 corresponding to the plurality of touch electrodes 41 on a substrate 31 by a photolithographic process; wherein, the substrate 31 includes a touch region 311 for touching and a signal line connection region 313 for external connection of the signal lines, the plurality of touch electrodes 41 are provided in the touch region 311, and the plurality of signal lines 61 are routed from the touch region 311 to the signal line connection region 313; reserving the photoresist used in the photolithographic process on the plurality of touch electrodes 41 and portions of the plurality of signal lines 61 in the touch region 311 without reserving the photoresist on portions of the plurality of signal lines 61 in the signal line connection region 313.

For example, the photolithographic process uses a multi-tone mask. The photolithographic process implemented by using the multi-tone mask, for example, is described as follows.

For example, a transparent conductive film 401 is formed on the substrate 31, and a photoresist film 501 is formed on the transparent conductive film 401, as shown in FIG. 4a; and the photoresist film 501 is exposed and developed to form a photoresist pattern 521. As shown in FIG. 4b, a thickness of a portion of the photoresist pattern 521 located in the signal line connection region 313 is less than a thickness of a portion of the photoresist pattern 521 located in the touch region 311; that is, the photoresist pattern 521 has different thicknesses in the signal line connection region 313 and the touch region 311, the photoresist pattern 521 comprises a photoresist pattern 77 having a smaller thickness in the signal line connection region 313 and a photoresist pattern 78 having a larger thickness in the touch region 311. The transparent conductive film 401 is etched by using the photoresist pattern 521 as a mask, to form the plurality of touch electrodes 41 and the plurality of signal lines 61, as shown in FIG. 4c.

An ashing process is performed on the photoresist pattern 521 to remove the portion of the photoresist pattern 521 (that is, the photoresist pattern 77 having the smaller thickness) in the signal line connection region 313, so as to expose the portions of the signal lines 61 in the signal line connection region 313, and reduce the thickness of the portion of the photoresist pattern in the touch region (that is, the thickness of the photoresist pattern 78 having the larger thickness is reduced). In this way, the photoresist pattern 78 having a reduced thickness is reserved in the touch region 311, as shown in FIG. 4d.

That is, the photoresist pattern 78 having the reduced thickness is still reserved to cover the touch electrodes 41 and the signal lines 61. Thus, the portions of the signal lines in the signal line connection region 313 are exposed for external connection of the signal lines. Since the touch electrodes and the portions of the signal lines 61 in the touch region 311 are protected by the photoresist, they are not easily scratched during bonding the signal lines with external circuits.

For example, the substrate 311 further includes a signal line expansion region 312, and the plurality of signal lines 61 enter the touch region 311 after expanded in the signal line expansion region 312, and the photoresist is also reserved on portions of the signal lines 61 in the signal line expansion region 312. That is, during exposing, developing the photoresist film 501 to form the photoresist pattern 521, the photoresist pattern 78 having the larger thickness is formed on the portions of the signal lines in the signal line expansion region 312; during performing the ashing process on the photoresist pattern 521, the photoresist pattern 78 having the larger thickness on the signal line expansion region 312 is also thinned, so that the photoresist pattern having a reduced thickness is reserved in the signal line expansion region 312. As shown in FIGS. 3d and 4d, during bonding the signal lines with external circuits, since the photoresist on the portions of the signal lines in the signal line expansion region 312 is also reserved, the portions of the signal lines in the signal line expansion region 312 are not easily scratched.

It should be noted that, the photoresist may be not reserved on the portions of the signal lines 61 in the signal line expansion region 312, that is, the portions of the plurality of signal lines in the signal line expansion region 312 are not covered with the photoresist. In this case, during exposing, developing the photoresist film 501 to form the photoresist pattern 521, the photoresist pattern 77 having the smaller thickness is formed on the portions of the signal lines in the signal line expansion region 312; during performing the ashing process on the photoresist pattern 521, the photoresist pattern 77 having the smaller thickness on the portions of the signal line expansion region 312 is also removed, as shown in FIG. 3c.

For example, the exposing process as described is implemented by using the multi-tone mask 7. In a case where a positive photoresist is used, a region to be etched on the substrate corresponds to a completely-transmissive region 72 of the mask 7, a region for forming the portions of the signal lines in the signal line connection region 313 corresponds to a semi-transmissive region 73 of the mask 7, and the other region of the mask 7 is a light-tight region 74, as shown in FIG. 4b. For example, the light-tight region 74 corresponds to the touch electrodes 41 and the portions of the signal lines 61 in the touch region 311, or, the light-tight region 74 corresponds to the touch electrodes 41 and the portions of the signal lines 61 in the touch region 311 and the portions of the signal lines 61 in the signal line expansion region 312. After the photoresist is exposed and developed by the multi-tone mask 7, the photoresist pattern 512 having two different thicknesses is formed on a surface of the transparent conductive film 401, that is, the photoresist pattern 78 having the larger thickness is formed in a region corresponding to the light-tight region of the mask 7, and the photoresist pattern 77 having the smaller thickness is formed in a region corresponding to the semi-transmissive region of the mask 7. The multi-tone mask 7 for example is a half-tone mask or a gray-tone mask.

For example, the transparent conductive film 401 is an ITO film.

For example, the substrate 31 is a glass substrate; an OGS touch screen is formed on a liquid crystal display panel by arranging a capacitive touch screen prepared by the above method on the liquid crystal display panel, as shown in FIG. 3b.

For example, in the case that the substrate 31 is an opposed substrate 31′ of the liquid crystal display panel, an On-Cell touch display panel is formed, the formed On-Cell touch display panel is shown in FIGS. 3c and 3d, and a structure of the liquid crystal display panel, for example, is as described above. For example, the opposed substrate 31′ is a color filter substrate. For example, during fabricating a touch structure, the touch structure is provided on the opposed substrate 31′ of the array substrate and opposed substrate bonded with each other.

For example, the substrate 31 is a plastic film, and a GFF touch screen is formed on the liquid crystal display panel by arranging the capacitive touch screen prepared by the above method on the liquid crystal display panel, as shown in FIG. 3e.

The touch display panel provided by the embodiments of the present disclosure may be applied to: a liquid crystal panel, an E-paper, a liquid crystal television, a digital frame, a cell phone, a watch, a tablet computer and any other products or parts having touching and displaying functions.

The embodiments of the present disclosure provide a capacitive touch screen and a preparation method thereof and a touch display panel. The capacitive touch screen comprises the substrate, the plurality of touch electrodes provided on the substrate, and the plurality of signal lines corresponding to the plurality of touch electrodes; the substrate includes the touch region for touching and the signal line connection region for external connection of the signal lines, the plurality of touch electrodes are provided in the touch region, and the plurality of signal lines are routed from the touch region to the signal line connection region; and the plurality of touch electrodes and the portions of the plurality of signal lines in the touch region are covered with a photoresist, and the portions of the plurality of signal lines in the signal line connection region are not covered with the photoresist. In the preparation method, the plurality of touch electrodes and the plurality of signal lines corresponding to the plurality of touch electrodes are formed on the substrate by a photolithographic process; the substrate includes the touch region for touching and the signal line connection region for external connection of the signal lines, the plurality of touch electrodes are provided in the touch region, and the plurality of signal lines are routed from the touch region to the signal line connection region, and the photoresist used in the photolithographic process is reserved on the plurality of touch electrodes and the portions of the plurality of signal lines in the touch region, and no photoresist is reserved on the portions of the plurality of signal lines in the signal line connection region. After the photoresist on the signal line connection region is removed, the photoresist in the other region is reserved, and the reserved photoresist corresponds to the touch electrodes and the portions of the signal lines in the touch region, and therefore, the touch electrodes and the portions of the signal lines in the touch region are protected from being easily scratched in follow-up process. The embodiments of the present disclosure effectively prevent the touch electrodes from being scratched in fabrication processes of the capacitive touch screen and the touch display panel, so that a product yield is improved.

The foregoing embodiments merely are specific implementation modes of the present disclosure, but a protection scope of the present disclosure is not limited thereto, changes or replacements easily conceived by any skilled in art within the technical scope disclosed by the present disclosure should be covered by the protection scope of the present disclosure. Thus, the protection scope of the present disclosure is determined by the claims.

The present application claims priority of Chinese Patent Application No. 201510185776.X filed on Apr. 17, 2015, the disclosure of which is incorporated herein by reference in its entirety as part of the present application.

1. A capacitive touch screen, comprising: a substrate, a plurality of touch electrodes provided on the substrate, and a plurality of signal lines corresponding to the plurality of touch electrodes, wherein,
the substrate includes a touch region for touching and a signal line connection region for external connection of the signal lines, the plurality of touch electrodes are provided in the touch region, and the plurality of signal lines are routed from the touch region to the signal line connection region, and
the plurality of touch electrodes and portions of the plurality of signal lines in the touch region are covered with a photoresist, and portions of the plurality of signal lines in the signal line connection region are not covered with the photoresist.

2. The capacitive touch screen according to claim 1, wherein, the touch electrodes comprise a touch driving electrode and/or a touch sensing electrode.

3. The capacitive touch screen according to claim 1, wherein, the touch electrodes and the signal lines are provided in a same layer.

4. The capacitive touch screen according to claim 1, wherein, the touch electrodes are made of a transparent conductive material.

5. The capacitive touch screen according to claim 1, wherein, the substrate further includes a signal line expansion region, the plurality of signal lines enter the touch region after expanded in the signal line expansion region, and portions of the signal lines in the signal line expansion region are covered with the photoresist.

6. A preparation method of a capacitive touch screen, comprising:
forming a plurality of touch electrodes and a plurality of signal lines corresponding to the plurality of touch electrodes on a substrate by a photolithographic process, wherein, the substrate includes a touch region for touching and a signal line connection region for external connection of the signal lines, the plurality of touch electrodes are provided in the touch region, and the plurality of signal lines are routed from the touch region to the signal line connection region; and
reserving a photoresist used in the photolithographic process on the plurality of touch electrodes and portions of the plurality of signal lines in the touch region without reserving photoresist on portions of the plurality of signal lines in the signal line connection region.

7. The preparation method of the capacitive touch screen according to claim 6, wherein, the photolithographic process uses a multi-tone mask.

8. The preparation method of the capacitive touch screen according to claim 7, wherein, the multi-tone mask is a half-tone mask or a gray-tone mask.

9. The preparation method of the capacitive touch screen according to claim 7, wherein, the photolithographic process using the multi-tone mask includes:
forming a transparent conductive film on the substrate;
forming a photoresist film on the transparent conductive film;
exposing, developing the photoresist film to form a photoresist pattern, wherein, a thickness of a portion of the photoresist pattern in the signal line connection region is less than a thickness of a portion of the photoresist pattern in the touch region;
etching the transparent conductive film by using the photoresist pattern as a mask, to form the touch electrodes and the signal lines; and
aching the photoresist pattern, to remove the portion of the photoresist pattern in the signal line connection region but reserve the portion of the photoresist pattern having a reduced thickness in the touch region.

10. The preparation method of the capacitive touch screen according to claim 9, wherein,
in the case that the photoresist film is formed of a positive photoresist, a region to be etched corresponds to a completely-transmissive region of the multi-tone mask, a region for forming the portions of the signal lines in the signal line connection region corresponds to a semi-transmissive region of the multi-tone mask, and a region for forming the touch electrodes and the portions of the signal lines in the touch region corresponds to a light-tight region of the multi-tone mask.

11. The preparation method of the capacitive touch screen according to claim 6, wherein,
the substrate further includes a signal line expansion region, the plurality of signal lines enter the touch region after expanded in the signal line expansion region, and the photoresist is also reserved on portions of the signal lines in the signal line expansion region.

12. The preparation method of the capacitive touch screen according to claim 6, wherein, the transparent conductive film is made of a transparent conductive material.

13. The preparation method of the capacitive touch screen according to claim 6, wherein, the substrate is an opposed substrate in a liquid crystal display panel.

14. A touch display panel, comprising a display panel and a touch structure located on the display panel, wherein,
the touch structure includes a plurality of touch electrodes, and a plurality of signal lines corresponding to the plurality of touch electrodes;
the display panel includes a touch region for touching and a signal line connection region for external connection of the signal lines, the plurality of touch electrodes are provided in the touch region, and the plurality of signal lines are routed from the touch region to the signal line connection region; and
the plurality of touch electrodes and portions the plurality of signal lines in the touch region are covered with a photoresist, and portions of the plurality of signal lines in the signal line connection region are not covered with the photoresist.

15. The touch display panel according to claim 14, wherein, the display panel further includes a signal line expansion region, the plurality of signal lines enter the touch region after expanded in the signal line expansion region, and portions of the signal lines in the signal line expansion region are covered with the photoresist.

16. The touch display panel according to claim 14, wherein, the touch electrodes and the signal lines are provided in a same layer.

17. The touch display panel according to claim 14, wherein, the touch electrodes are made of a transparent conductive material.

18. The touch display panel according to claim 14, wherein, the display panel is a liquid crystal panel, and includes an array substrate, an opposed substrate, and liquid crystal sealed between the array substrate and the opposed substrate by a sealant.

19. The touch display panel according to claim 18, wherein, the touch structure is provided on the opposed substrate.
